(19) United States
(12) Patent Application Publication
(10) Pub. No.: US 2008/0300333 A1
(43) Pub. Date: Dec. 4, 2008

(54) Process for Preparation of Vinylaromatic-Vinyl Cyanide Copolymers Comprising Anhydrides

(75) Inventors: Martin Weber, Maikammer (DE); Peter Ittemann, Lampertheim (DE); Axel Gottschalk, Neustadt (DE); Bernd Niedermaier, Ludwigshafen (DE); Birgit Reinhard, Limburgerhof (DE); Cornelius Eme Koning, Brunssum (NL); Lubertus Klumperman, Leiderdorp (NL); Maarten Pieter Bram Staal, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/093,004

(22) PCT Filed: Nov. 10, 2006
(86) PCT No.: PCT/EP2006/068331

§ 371 Date: May 8, 2008

(30) Foreign Application Priority Data
Nov. 16, 2005 (DE) 10 2005 055 080.0

(51) Int. Cl. C08L 35/06; C08J 9/00

(52) U.S. Cl. 521/147; 524/845; 524/811

(57) ABSTRACT

The present invention relates to a process for preparation of copolymers A) comprising
A1) one or more vinylaromatic monomers,
A2) one or more vinyl cyanides, and
A3) one or more dicarboxylic anhydrides

via bulk polymerization or via solution polymerization,

an important feature of the invention being that the polymerization is carried out in the presence of from 0.01 to 0.5% by weight of water, based on the total weight of the polymerization mixture.

The present invention further relates to the copolymers A), to thermoplastic molding compositions comprising the copolymers A), to the use of the copolymers A) and of the thermoplastic molding compositions, and also to the moldings, foils, fibers, or foams obtainable from the copolymers A) or from the thermoplastic molding compositions.

The present invention relates to a process for preparation of copolymers A) comprising A1) one or more vinylaromatic monomers, A2) one or more vinyl cyanides, and A3) one or more dicarboxylic anhydrides, via bulk polymerization or via solution polymerization.

The present invention further relates to the copolymers A), to thermoplastic molding compositions comprising the copolymers A), to the use of the copolymers A) and of the thermoplastic molding compositions, and also to the moldings, foils, fibers, or foams obtainable from the copolymers A) and from the thermoplastic molding compositions.

Vinylaromatic-vinyl cyanide copolymers comprising anhydride are known per se, an example being styrene-acrylonitrile-maleic anhydride copolymers, as also are processes for their preparation.

By way of example, DT 25 40 517 A1 discloses polymers based on styrene, acrylonitrile, and maleic anhydride which are prepared via a specific continuous bulk polymerization reaction in a plurality of stages of a process in the presence of polymerization initiators. The residual monomer contents of the polymers are lowered to contents less than 0.5% by weight via application of vacuum or introduction of inert gas.

EP 0 001 625 A1 relates inter alia to specific terpolymers composed of styrene, acrylonitrile, and maleic anhydride. They are prepared via continuous bulk polymerization in the presence of an initiator which decomposes to give free radicals. In subsequent steps of a process, the residual monomer contents are lowered below 0.1% by weight via evaporation or injection of inert gas.

EP 0 433 711 A2 describes specific processes for preparation of terpolymers based on styrene, acrylonitrile, and maleic anhydride, in which the reaction of the monomers takes place in bulk without addition of solvents or of diluents. In one preferred embodiment, the polymerization reaction is initiated thermally without addition of chemical initiators. Residual monomers can be removed in subsequent stages of a process.

DE 100 58 302 A1 discloses stabilized styrene copolymers comprising vinylaromatic monomers and one or more comonomers. The styrene copolymers are in particular prepared in bulk or in solution. The polymerization reaction can be initiated via addition of chemical initiators or thermally.

The copolymers that can be prepared by the known processes and that are composed of vinylaromatic monomers, of vinyl cyanides, and of dicarboxylic anhydrides are often still unsatisfactory in terms of their intrinsic color, melt stability, and residual contents of low-molecular-weight compounds [for the purposes of this invention the definition of low-molecular-weight compounds being compounds whose average (weight-average) molar mass M_{w} is less than or equal to 10000 g/mol, determined via gel permeation chromatography at 35° C. using three polystyrene gel columns from Polymer Laboratories arranged in series, with tetrahydrofuran as eluent (calibration with polystyrene standard), using the UV detector signal].

An object underlying the present invention was therefore to provide copolymers which are based on vinylaromatic monomers, on vinyl cyanides, and on dicarboxylic anhydrides and which have less intrinsic color, higher melt stability, and/or lower residual contents of low-molecular-weight compounds. Suitable preparation processes should also be provided for these copolymers with improved properties.

Accordingly, the processes defined at the outset have been found for preparation of the copolymers A), and it is important for the invention here that the monomers are polymerized in the presence of from 0.01 to 0.5% by weight of water, based on the total weight of the polymerization mixture.

Furthermore, copolymers A) based on vinylaromatic monomers, on vinyl cyanides, and on dicarboxylic anhydrides have been found, as also have thermoplastic molding compositions comprising these copolymers A), the uses of these copolymers A) and of these thermoplastic molding compositions, and moreover moldings, foils, fibers, or foams comprising these copolymers A) and, respectively, these thermoplastic molding compositions.

The inventive processes, copolymers, thermoplastic molding compositions, uses, and moldings, foils, fibers, or foams are described below.

In principle, any of the bulk-polymerization or solution-polymerization processes known to the person skilled in the art and described in the prior art, for example in DE 100 58 302 A1 and in the documents cited therein, is suitable as inventive process for preparation of the copolymers A) comprising A1) one or more vinylaromatic monomers, A2) one or more vinyl cyanides, and A3) one or more dicarboxylic anhydrides, as long as the monomers are polymerized in the presence of from 0.01 to 0.5% by weight, preferably from 0.03 to 0.4% by weight, particularly preferably from 0.05 to 0.3% by weight, of water, based on the total weight of the polymerization mixture.

The component A1) used can comprise any of the vinylaromatic monomers known to the person skilled in the art and described in the prior art, for example in DE 100 58 302 A1; those preferably used being styrene, α-methylstyrene, p-methylstyrene, tert-butylstyrene, vinylnaphthalene, or a mixture of these; particular preference being given to use of styrene.

The component A2) used can comprise any of the vinyl cyanides known to the person skilled in the art and described in the prior art, for example in DT 25 40 517 A1; those preferably used being acrylonitrile, methacrylonitrile, or a mixture of these; particular preference being given to use of acrylonitrile.

The component A3) used can comprise any of the dicarboxylic anhydrides known to the person skilled in the art and described in the prior art; preference being given to use of maleic anhydride, methylmaleic anhydride, itaconic an hydride, or a mixture of these; particular preference being given to use of maleic anhydride.

The component A4) used in the inventive copolymers A) can comprise monomers other than components A1), A2), and A3), but copolymerizable with these.

The copolymers A) are particularly preferably styrene-acrylonitrile-maleic anhydride copolymers.

The copolymers A) usually comprise

from 50 to 94.7% by weight, preferably from 59 to 89% by weight, particularly preferably from 68 to 78.5% by weight, of component A1),
from 5 to 49.7% by weight, preferably from 10 to 40% by weight, particularly preferably from 20 to 30.5% by weight, of component A2),
from 0.3 to 10% by weight, preferably from 1 to 8% by weight, particularly preferably from 1.5 to 6% by weight, of component A3), and
from 0 to 25% by weight, preferably from 0 to 15% by weight, particularly preferably from 0 to 10% by weight, of component A4),
where each of the % by weight figures is based on the total weight of components A1), A2), A3), and A4), and their total is 100% by weight.

The copolymers A) are prepared via bulk polymerization or solution polymerization, but preferably by solution polymerization in the presence of an organic solvent, such as cyclohexane, ethylbenzene, or dimethyl sulfoxide, preferably ethylbenzene.

In principle, both in the solution polymerization reaction and in the bulk polymerization reaction, the polymerization reaction can be initiated via addition of chemical polymerization initiators, for example as described in DE 100 58 302 A1; however, purely thermal initiation is preferred, i.e. without addition of any polymerization initiator. The batch or semibatch preparation process can be used, but it is preferable to use continuous conduct of a process.

In one particularly preferred embodiment of the inventive processes, the conduct of the process is continuous under steady-state conditions; steady-state conditions means that the concentration of all of the reactants and the constitution of the copolymers A) formed remain practically constant over the reaction time. (Information on the relationship between monomer constitution and polymer constitution, and also on the steady-state conduct of the reaction, can in particular be found in EP 0 001 625 A1 and DT 25 40 517 A1).

Suitable process parameters, such as pressure, temperature, residence times, etc., suitable apparatus for conduct of the processes, and also suitable rates of flow for feed of the monomers, and of the solvents, if present, and of the initiators, if present, and of other polymerization additives, if appropriate, are known to the person skilled in the art and are described in the prior art.

It is important for the invention that the monomers are polymerized in the presence of the specified amounts of water. The water can be added separately to the polymerization mixture, but it can also be added to one of the monomer streams or—if present—solvent streams metered in. The water added to the polymerization mixture preferably takes the form of a mixture with component A2).

The work-up of the polymerization mixture and the isolation of the copolymers A) can take place by methods known to the person skilled in the art and described in the prior art, for example via removal of low-molecular-weight compounds by means of application of vacuum or stripping with inert gas.

The copolymers A) prepared by the inventive processes in the presence of the specified amounts of water in the polymerization mixture differ from copolymers prepared without presence of the specified amounts of water in the polymerization mixture but otherwise by comparable processes in that they have less intrinsic color, have higher melt stability, and/or have lower residual contents of low-molecular-weight compounds.

The inventive copolymers A) can be processed with other thermoplastic polymers B), such as styrene-acrylonitrile copolymers (SAN), polyamide (PA), poly(meth)acrylates (PMMA), or polycarbonates (PC), and with rubbers C), such as polybutadiene rubbers or acrylate rubbers, and with particulate or fibrous fillers, or with particulate or fibrous reinforcing materials D), in particular glass fibers, and/or with additives E) conventional in plastics, e.g. heat stabilizers, UV stabilizers, lubricants, flame retardants, antistatic agents, dyes, color pigments, etc., to give thermoplastic molding compositions.

Preferred thermoplastic molding compositions comprise

from 1 to 95% by weight of copolymers A),
from 5 to 99% by weight of one or more thermoplastic polymers B) other than component A),
from 0 to 50% by weight of one or more rubbers C),
from 0 to 40% by weight of one or more particulate or fibrous fillers or particulate or fibrous reinforcing materials D), and
from 0 to 25% by weight of one or more additives E) conventional in plastics,
where each of the % by weight figures is based on the total weight of components A), B), C), D), and E) and their total is 100% by weight.

Components B), C), D), and E) per se are known to the person skilled in the art and are described in the prior art, as also are processes for preparation of the thermoplastic molding compositions from the individual components.

The inventive copolymers A) and the thermoplastic molding compositions comprising the copolymers A) can be used to produce moldings, foils, fibers, or foams, by processes known to the person skilled in the art and described in the prior art, e.g. injection molding, compression molding, calendering, or extrusion.

Examples are used below for further explanation of the invention.

### EXAMPLES

In each of the inventive examples and comparative examples below, copolymers were prepared and their properties were determined.

### Starting Materials:

Commercially available styrene (purum) from Fluka Riedel-de Haen (Sigma-Aldrich) was used as component A1-i.

Commercially available acrylonitrile (purum) from Fluka Riedel-de Haen (Sigma-Aldrich) was used as component A2-i.

Commercially available maleic anhydride (purum) from Fluka Riedel-de Haen (Sigma-Aldrich) was used as component A3-i.

Commercially available ethylbenzene (purum) from Fluka Riedel-de Haen (Sigma-Aldrich) was used as solvent for the polymerization reaction.

All of the specified components A1-i, A2-i, A3-i, and solvent, were distilled immediately prior to their use. The water content of the distilled components A1-i, A2-i, A3-i, and solvent, was determined via Karl Fischer titration and in each case was less than 0.01% by weight, based on the respective component or solvent.

### Preparation and Properties of Copolymers

The respective parts by weight specified in Table 1 of components A1), A2), A3) and of the solvent and deionized water (no water being added in the comparative experiments) were metered per unit of time into a stationary-state continuously operated stirred tank (continuously-operated tank), flushed with nitrogen. In each case the temperature of the polymerization mixture was 145° C., and in each case purely thermal initiation of the polymerization reaction was used. In each case, polymerization mixture with copolymer solids content of 50% by weight, based on the total weight of the polymerization mixture, was continuously drawn off from the stirred tank, and in each case identical methods were used in two stages to remove unreacted monomers, solvents, and other low-molecular-weight compounds. Each of the copolymers obtained was pelletized and dried. These pellets were used for production of test specimens for testing of certain properties in an injection-molding machine at melt temperature 240° C. and mold-surface temperature 60° C.

The Following Properties were Determined:

Viscosity number VN [ml/g]:

Viscosity number VN was determined at 25° C. on a 0.5% strength by weight solution of the respective copolymer in dimethylformamide to DIN 53726.

Yellowness index YI [dimensionless]:

Yellowness index (yellow tinge) YI was determined to ASTM D1925 on injection-molded plaques (dimensions: 60 mm×60 mm×2 mm; melt temperature during injection molding 240° C.; mold temperature during injection molding 60° C.).

Change in melt viscosity as a measure of melt stability [%]:

The melt viscosity η of the copolymers was determined using a high-pressure capillary rheometer (Rheograph 2003) from Göttfert at a shear rate of 55 Hz at a melt temperature of 300° C. after, respectively, 5 min (η⁵) and 30 min (η³⁰). The measure of melt stability is calculated by in each case taking the numeric difference in melt viscosities after 30 min and after 5 min as a ratio to melt viscosity after 5 min and multiplying by 100%:

|η³⁰−η⁵|*100%/η⁵.

Content of low-molecular-weight compounds [% by weight]

Content by weight of compounds whose average (weight-average, determined by means of GPC) molar mass M_{w} is 10000 g/mol or less, based on the total weight of the copolymers, determined via gel permeation chromatography at 35° C. using three polystyrene gel columns from Polymer Laboratories arranged in series, with tetrahydrofuran as eluent (calibration with polystyrene standard), using the UV detector signal.

The parts by weight of the components metered in, of the solvent, and of the deionized water, these being the materials used to prepare the copolymers, are found in Table 1, as also are the properties of the copolymers.

TABLE 1
Parts by weight of components metered in, of solvent, and of
deionized water, and properties of copolymers

| Example* | c-1 | 2 | c-3 | 4 | 5 | c-6 |
|---|---|---|---|---|---|---|
| Parts by weight | | | | | | |
| A1-i | 53 | 53 | 53 | 53 | 53 | 53 |
| A2-i | 19 | 19 | 17 | 17 | 17 | 17 |
| A3-i | 2 | 2 | 4 | 4 | 4 | 4 |
| Solvent | 26 | 26 | 26 | 26 | 26 | 26 |
| Water** | 0 | 0.1 | 0 | 0.08 | 0.3 | 0.6 |
| Properties | | | | | | |
| Viscosity number VN [ml/g] | 66 | 67 | 66 | 66 | 67 | 67 |
| Yellowness index YI | 23 | 9 | 31 | 11 | 10 | 25 |
| [dimensionless] | | | | | | |
| Melt stability [%] | 43 | 12 | 54 | 14 | 15 | 19 |
| Low-molecular-weight | 7.2 | 4.3 | 8.2 | 4.3 | 4.4 | 5.7 |
| compounds [% by weight] | | | | | | |

*Examples indicated by “c” are comparative examples.
**In the comparative examples in which no water was metered in, water content of the polymerization mixture was determined via Karl Fischer titration; it was in each case less than 0.01% by weight, based on the total weight of the polymerization mixture.

The examples provide evidence of the lower level of intrinsic color, the higher melt stability, and the lower residual contents of low-molecular-weight compounds in the copolymers A) prepared according to the invention.

1. A process for preparation of copolymers A) comprising
A1) one or more vinylaromatic monomers,
A2) one or more vinyl cyanides, and
A3) one or more dicarboxylic anhydrides
via bulk polymerization or via solution polymerization,
which comprises carrying out the polymerization in the presence of from 0.01 to 0.5% by weight of water, based on the total weight of the polymerization mixture.

2. The process according to claim 1, wherein the polymerization is initiated thermally, without addition of any polymerization initiator.

3. The process according to claim 1, wherein the polymerization is a solution polymerization carried out in the presence of an organic solvent.

4. The process according to claim 1, wherein the copolymers A) comprise
from 50 to 94.7% by weight of one or more vinylaromatic monomers A1),
from 5 to 49.7% by weight of one or more vinyl cyanides A2),
from 0.3 to 10% by weight of one or more dicarboxylic anhydrides A3), and
from 0 to 25% by weight of other copolymerizable monomers A4),
where each of the % by weight figures is based on the total weight of components A1), A2), A3), and A4), and their total is 100% by weight.

5. The process according to claim 1, wherein component A1) is styrene, α-methylstyrene, p-methylstyrene, tert-butylstyrene, vinylnaphthalene, or a mixture composed of two or more of these monomers, component A2) is acrylonitrile, methacrylonitrile, or a mixture of these monomers, and
component A3) is maleic anhydride, methylmaleic anhydride, itaconic anhydride, or a mixture composed of two or more of these monomers.

6. The process according to claim 1, wherein the copolymer A) is a styrene-acrylonitrile-maleic anhydride copolymer.

7. A copolymer A), which can be prepared by a process according to claim 1.

8. A thermoplastic molding composition comprising
from 1 to 95% by weight of copolymers A) according to claim 7,
from 5 to 99% by weight of one or more thermoplastic polymers B) other than component A),
from 0 to 50% by weight of one or more rubbers C),
from 0 to 40% by weight of one or more particulate or fibrous fillers or particulate or fibrous reinforcing materials D), and
from 0 to 25% by weight of one or more additives E) conventional in plastics,
where each of the % by weight figures is based on the total weight of components A), B), C), D), and E) and their total is 100% by weight.

9. The method of preparing the copolymer A) according to claim 7 for production of moldings, of foils, of fibers, or of foams.

10. A molding, a foil, a fiber, or a foam obtainable from the copolymers A) according to claim 7.

11. The method of preparing the thermoplastic molding composition according to claim 8 for production of moldings, of foils, of fibers, or of foams.

12. A molding, a foil, a fiber, or a foam obtainable from the thermoplastic molding composition according to claim 8.

13. The process according to claim 2, wherein the polymerization is a solution polymerization carried out in the presence of an organic solvent.

14. The process according to claim 2, wherein the copolymers A) comprise
from 50 to 94.7% by weight of one or more vinylaromatic monomers A1),
from 5 to 49.7% by weight of one or more vinyl cyanides A2),
from 0.3 to 10% by weight of one or more dicarboxylic anhydrides A3), and
from 0 to 25% by weight of other copolymerizable monomers A4),
where each of the % by weight figures is based on the total weight of components A1), A2), A3), and A4), and their total is 100% by weight.

15. The process according to claim 3, wherein the copolymers A) comprise
from 50 to 94.7% by weight of one or more vinylaromatic monomers A1),
from 5 to 49.7% by weight of one or more vinyl cyanides A2),
from 0.3 to 10% by weight of one or more dicarboxylic anhydrides A3), and
from 0 to 25% by weight of other copolymerizable monomers A4),
where each of the % by weight figures is based on the total weight of components A1), A2), A3), and A4), and their total is 100% by weight.

16. The process according to claim 2, wherein
component A1) is styrene, α-methylstyrene, p-methylstyrene, tert-butylstyrene, vinylnaphthalene, or a mixture composed of two or more of these monomers, component A2) is acrylonitrile, methacrylonitrile, or a mixture of these monomers, and
component A3) is maleic anhydride, methylmaleic anhydride, itaconic anhydride, or a mixture composed of two or more of these monomers.

17. The process according to claim 3, wherein
component A1) is styrene, α-methylstyrene, p-methylstyrene, tert-butylstyrene, vinylnaphthalene, or a mixture composed of two or more of these monomers, component A2) is acrylonitrile, methacrylonitrile, or a mixture of these monomers, and
component A3) is maleic anhydride, methylmaleic anhydride, itaconic anhydride, or a mixture composed of two or more of these monomers.

18. The process according to claim 4, wherein component A1) is styrene, α-methylstyrene, p-methylstyrene, tert-butylstyrene, vinylnaphthalene, or a mixture composed of two or more of these monomers, component A2) is acrylonitrile, methacrylonitrile, or a mixture of these monomers, and
component A3) is maleic anhydride, methylmaleic anhydride, itaconic anhydride, or a mixture composed of two or more of these monomers.

19. The process according to claim 2, wherein the copolymer A) is a styrene-acrylonitrile-maleic anhydride copolymer.

20. The process according to claim 3, wherein the copolymer A) is a styrene-acrylonitrile-maleic anhydride copolymer.
